(19) United States
(12) Patent Application Publication
(10) Pub. No.: US 2010/0077570 A1
(43) Pub. Date: Apr. 1, 2010

(54) BIOCLIP

(75) Inventors: Joachim Meyrahn, Erzhausen (DE); Klaus Hein, Gedern (DE)

Correspondence Address: HAHN LOESER & PARKS, LLP, One GOJO Plaza, Suite 300, AKRON, OH, 44311-1076, US

(73) Assignee: POLY-CLIP SYSTEM GMBH & CO. KG, Frankfurt/Main (DE)

(21) Appl. No.: 12/566,345

(22) Filed: Sep. 24, 2009

(30) Foreign Application Priority Data
Sep. 25, 2008 (DE) 102008048858.5-27

(51) Int. Cl. B65D 33/16; B23P 17/00

(52) U.S. Cl. 24/30.5 R; 29/527.1

(57) ABSTRACT

A closure clip for closing tube-type or pouch-type packaging material, comprising two substantial identical limbs which span a clip plane and are connected by a connecting section, wherein the closure clip consists of a plastic and can be closed in a cold forming process. And, material for such closure clips, and to a method for producing them.

### BACKGROUND AND SUMMARY OF THE INVENTION

The present invention relates to a closure clip for closing tube-type or pouch-type packaging material. The invention also relates to a material for such closure clips, and to a method for producing them.

It is known, in practice, that when producing products packed in sausage-shaped or tubular pouch-shaped casings, such as sausage products, the filling material, provided in the form of sausage meat for the sausage product, is fed by a filling machine to a clipping machine via a filling tube. In the clipping machine, the filling material is stuffed into a tubular casing material, which is closed at one end by a first closure clip or a first clip, and the tubular casing material is closed by placing a second clip. Each pair of closing tools comprises an upper die and a lower die, between which the clip is shaped during closure until the minimum distance between the closing tools is reached. After closure, the closing tools are returned to their initial or open position. The casing material of the resultant sausage product is then separated from the remaining supply of casing material, and the sausage product thus finished is carried out of the clipping machine.

Such a closure must meet high quality standards. On the one hand, it must not be so firm that the casing is damaged during closure. On the other hand, however, the closure must be sufficiently secure and tight so that the clip does not slip off the casing material and/or that sausage meat does not escape from the casing material when the sealed sausage is subjected to further subsequent processing, such as cooking, smoking, etc. For that reason, closure clips have normally been produced of metal until now. In addition to these requirements for reliable closure, however, attention is also being increasingly focused on environmental compatibility aspects, such as recyclability or biodegradability of the materials being used.

Such closure clips are known, for example, from the German laid-open patent specification DE 31 48 757 (AU 9152082). These closure clips, or clips for short, are made from a strand of metal, e.g., of aluminum, are pre-bent into a U-shape and fed as a contiguous line of clips to a first closing tool of the clipping machine, such as the lower die, by means of connecting webs formed by the bent ends of their side limbs. As a material, metal provides the necessary strength properties, but to ensure proper disposal, metal clips would have to be disposed of separately from the casing. Another disadvantage concerns the strong closing forces required to close the metal clips, which involve increased energy input and result in severe wear and tear.

The closure clips disclosed in the German laid-open patent specification DE 201 17 733 are produced from a spring-elastic plastic. In order to maintain a closing force, the limbs of said closure clips, which are configured as a clamping finger and a clamping slot, have outer and inner detent and counter detent elements, which interlock when the clamping finger engages the clamping slot on closing the closure clips. This known plastic closure clip cannot be used on conventional clipping machines due to its special closure mechanism, since special guiding devices must be provided in order to achieve correct engagement of the clamping finger in the clamping slot. Since the material is a spring-elastic plastic, secure closure is ensured only by the snap-in locking mechanism.

From DE 601 06 596 (US20020132960), it is also known to make plastic parts, such as handles, films, closure parts and the like, from different kinds of plastic. These plastics are mixtures of polyesters and additives such as cellulose or starch. Fibrous additives, above all, improve the strength of these mixtures. To improve biodegradability, the degradable additives are added in large proportions of up to 95%.

An object of the present invention is to overcome these disadvantages and to provide a closure clip that is easier to process and better to dispose of.

What is proposed, in particular, is a closure clip for closing tube-type or pouch-type packaging material, comprising two substantial identical limbs which span a clip plane and are connected by a connecting section. The inventive closure clip consists of a plastic and can be closed in a cold forming process.

Due to the use of plastic, the forces necessary to close the closure clip are significantly reduced in comparison to metal clips. The cold formability of the inventive closure clip also allows the clip, if designed accordingly, to be processed on existing clipping machines. It is therefore possible, in essence, to process not only “R-clips”, i.e., closure clips which are connected to each other at their bent ends to form a line of clips, but also “S-clips”, or U-shaped clips that are arranged in a concatenation of perfectly overlapping clips to form a line of clips.

In one advantageous embodiment of the inventive closure clip, the plastic is preferably biodegradable. This means that when natural gut, for example, is used for the sausage casing, the clips do not have to be disposed of separately from such natural gut casings.

In order to ensure biodegradability, a biodegradation accelerator that starts and maintains the biodegradation process under certain ambient conditions is admixed to the plastic. The biodegradation speed of plastic is significantly higher when such a biodegradation accelerator is used than in the case of natural biodegradation, if indeed the latter occurs at all.

In another advantageous embodiment, the biodegradation speed is adjustable. This can occur in various ways, for example by using different types and/or different amounts of biodegradation accelerator. It is preferred that only one biodegradation accelerator be used and that the biodegradation speed can be adjusted by altering the proportional amount of biodegradation accelerator. Using only one biodegradation accelerator facilitates the production process and reduces production costs. The biodegradation accelerator may be advantageously provided in the form of a pro-oxidant.

It has been found that the proportion of biodegradation accelerator is advantageously in a range between 0.1% and 30%, preferably between 1% and 10%, wherein a range between 1% and 4% is considered to be particularly preferred. Since a low proportion of biodegradation accelerator is sufficient to achieve a sufficiently high biodegradation speed, the mechanical properties of the plastic being used are not affected to any significant degree.

In one preferred embodiment, the plastic is a thermoplastic plastic.

Polycarbonate has been found to be a suitable plastic. It can be cold formed well and has sufficiently good mechanical properties. Other thermoplastics, such as polyolefines, and in particular polypropylene or polyethylene, can be used alternatively, however.

Production of the inventive clips is carried out by firstly feeding a granulate of the plastic to an extruder, from which a strand of material is then extruded.

Conventional extruders may be used for this purpose. An appropriate amount of biodegradation accelerator is preferably admixed to the granulate before extrusion. The extruded strand of material is then formed into a line of clips while still in a heated state, preferably just above the glass transition temperature, and is subsequently cooled.

### BRIEF DESCRIPTION OF THE DRAWING FIGURES

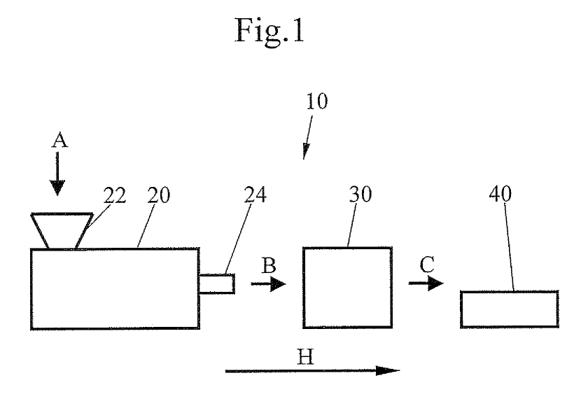

The production process for the inventive clips shall now be described with reference to the only FIG. 1, which shows a schematic view of a production device.

### DETAILED DESCRIPTION

As can be seen from FIG. 1, the production device 10 has an extruder 20, to which a forming device 30 and a cooling unit 40 are connected downstream.

Extruder 20 has, inter alia, a feeder for plastic granulate A, in the form of a hopper 22 which is shown schematically, as well as an extrusion tool which is embodied as nozzle 24. In the direction of production, i.e. from left to right in FIG. 1, a forming tool 30 that gives the strand of material exiting from the extruder its final shape is connected to extruder 20 downstream therefrom.

It is advantageous when a device for cooling the strand of melt extrudate is also located between nozzle 24 and forming tool 30 and which cools the strand of melt extrudate to the rubbery elastic region.

During the forming operation in forming tool 30, the strand of material is further cooled, namely at least to a temperature lower than the glass transition temperature of the plastic material.

In the direction of production H, forming tool 30 is followed by a cooling device 40 which cools the strand of material dispensed by forming tool 30 and which is still warm, to such an extent that it can easily be further processed or transported.

To produce a line of clips comprising the clips of the invention, the plastic material to be used, in this case polycarbonate, for example, is filled as a granulate via hopper 22 into extruder 20, which is known per se. A specific amount of a biodegradation accelerator is previously added to the granulate.

In extruder 20, which may be a screw-type extruder, for example, granulate A and the biodegradation accelerator are further mixed, melted by friction and/or a heater, and compressed. At the right-hand end of extruder 20, in FIG. 1, an extrusion tool in the form of a nozzle 24 is shown schematically. The viscous melt is generally pressed out of extruder 20 through nozzle 24. The cross-section of nozzle 24 defines the cross-section of the extruded strand. The strand of material B exiting from nozzle 24 can already have its final cross-section. In the present case, this may be an approximately rectangular cross-section. It is not necessary, therefore, to carry out after-treatment because of ridges or the like.

The temperature of the strand of material B exiting from nozzle 24 is higher than the glass transition temperature Tg, which for polycarbonate is approximately 145° C. Strand of material B, which is still easily formable, therefore, is fed to a forming device, such as a press.

In forming device or press 30, which may contain upper and lower dies, for example, strand of material B is shaped by a suitable forming process into the approximately corrugated line of clips C and cooled. Press 30 may operate intermittently or continuously. In addition to the aforementioned press 30, rotatable rollers may also be used for the forming process.

The semi-endless line of clips C exiting from press 30 has the final shape of clips connected to one another at their bent ends. Since it still has a very high temperature, it is fed to a cooling device 40 to prevent any deformation. These cooling devices, which are known per se, can be electrical, that is, they can operate with suitable cooling elements. However, since there is no risk of corrosion in the case of plastics, cooling system 40 can be operated in the simplest case with water as coolant.

Immediately after leaving the cooling device, the finished line of clips C can be wound onto a suitable storage reel. If a sterilization process is performed prior to winding, the storage reel can be dispatched directly for further processing. Of course, it is also possible to send the storage reel to a customer or to a further processing station without sterilization being carried out.

The clip produced in this manner and made, for example, of polycarbonate, has strength properties that are similar to those of a metal clip. It can also be cold formed well. This means that the clips of the invention can be processed on known clipping machines.

During processing, the degradation additive is temporarily stable at temperatures up to approximately 290° C. The glass transition temperature of polycarbonate is approximately 145° C., below which temperature the polycarbonate is solid. For this reason, almost all conceivable after-treatments of the packagings in which the clip of the invention is used, such as packagings for sausage products that in many cases are boiled or smoked, and which are carried out at temperatures up to about 100° C., can be carried out without difficulty.

However, since significantly less force is required to form it, clipping machines for sausage production, for example, can operate with lower pressure when using the plastic clip of the invention. This also saves energy and reduces wear and tear of the clipping machines.

Experiments have shown that acceptable degradation times result even when the proportional amount of biodegradation accelerator is only 1-2%. Increasing this proportional amount shortens the degradation time in an approximately linear relationship. Whereas the degradation time is approximately ten years when the proportional amount of biodegradation accelerator is 1-2%, the degradation time halves, under the same conditions, when the proportion of biodegradation accelerator is double that amount.

The biodegradation accelerator contains, inter alia, so-called pro-oxidants, for example Mn-based pro-oxidants which split the long-chain polymers of the plastic being used. This results in abiotic decomposition, or oxidative decomposition, in which the long-chain molecules are split into chain lengths that enable microbiotic decomposition.

Thus, in this type of biodegradation, the polymers are decomposed and not only the biodegradable or biologically decomposable additives.

Not only the aforementioned polycarbonate, but also other plastics such as polyethylene are suitable for this type of biodegradation.

The clips made of these materials need no longer be separated from the sausage casing, but can be disposed of together with the latter when the sausage casing is a natural gut casing or consists of some other material that is likewise biodegradable. This can reduce waste disposal costs. A contribution to environmental protection is also made.

Of course, the inventive plastic described in the foregoing can also be used for products other than the plastic clips referred to above.

Due to its having sufficiently good mechanical properties, it is also possible to make other components from it that are subjected to greater loads, and which need only survive a limited service life, such as loops or hooks. On account of its good biodegradation characteristics, the plastic according to the invention is particularly well suited for all non-returnable uses.

Nor is premature biodegradation a cause for concern, because certain ambient conditions must prevail before the biodegradation process can be initiated.

Having described the invention, what is claimed is:

1. A closure clip for closing tube-type or pouch-type packaging material, comprising two substantially identical limbs which span a clip plane and are connected by a connecting section, wherein the closure clip comprises a plastic and can be closed in a cold forming process.

2. The closure clip of claim 1, wherein the plastic is biodegradable.

3. The closure clip of claim 2, wherein a biodegradation accelerator is admixed with the plastic.

4. The closure clip of claim 3, wherein the biodegradation speed is adjustable.

5. The closure clip of claim 4, wherein the biodegradation speed is adjusted by altering the proportional amount of biodegradation accelerator.

6. The closure clip of claim 3, wherein the biodegradation accelerator is a pro-oxidant.

7. The closure clip of claim 5, wherein the proportion of biodegradation accelerator is in a range between 0.1% and 30.

8. The closure clip of claim 5, wherein the proportion of biodegradation accelerator is in a range between 1% and 10%.

9. The closure clip of claim 5, wherein the proportion of biodegradation accelerator is in a range between 1% and 4%.

10. The closure clip of claim 1, wherein the plastic is a thermoplastic plastic.

11. The closure clip of claim 10, wherein the plastic is polycarbonate.

12. The closure clip of claim 10, wherein the plastic is a polyolefin

13. The closure clip of claim 12, wherein the plastic is a polypropylene or a polyethylene.

14. A material for a closure clip for closing tube-type or pouch-type packaging material according to claim 1, wherein the material is a plastic which can be formed in a cold forming process.

15. The material of claim 14, wherein the plastic is biodegradable.

16. The material of claim 15, wherein a biodegradation accelerator is admixed with the plastic.

17. The material of claim 16, wherein the biodegradation speed is adjustable.

18. The material of claim 17, wherein the biodegradation speed is adjusted by altering the proportional amount of biodegradation accelerator.

19. The material of claim 16, wherein the biodegradation accelerator is a pro-oxidant.

20. The material of claim 17, wherein the proportion of biodegradation accelerator is in a range between 0.1% and 30%.

21. The material of claim 17, wherein the proportion of biodegradation accelerator is in a range between 1% and 10%.

22. The material of claim 17, wherein the proportion of biodegradation accelerator is in a range between 1% and 4.

23. The material of claim 14, wherein the plastic is a thermoplastic plastic.

24. The material of claim 23, wherein the plastic is polycarbonate.

25. The material of claim 23, wherein the plastic is a polyolefin

26. The material of claim 25, wherein the plastic is a polyethylene or a polypropylene.

27. A method for producing the cold-formable plastic closure clips of claim 1, comprising the steps:
feeding a plastic granulate into an extruder
extruding a stand of material
forming the strand of material into a strand consisting of connected closure clips arranged one after the other.

28. The method of claim 27, wherein a biodegradation accelerator is admixed with the plastic granulate.

29. The method of claim 28, wherein the proportion of biodegradation accelerator is in a range between 0.1% and 30%

30. The method of claim 28, wherein the proportion of biodegradation accelerator is in a range between 1% and 10%,

31. The material of claim 28, wherein the proportion of biodegradation accelerator is in a range between 1% and 4.

32. The method of claim 27, wherein the plastic is a thermoplastic plastic.

33. The method of claim 27, wherein the plastic is polycarbonate.

34. The method of claim 27, wherein the plastic is a polyolefin.

35. The method of claim 34, wherein the plastic is a polypropylene or a polyethylene.
